(19) United States
(12) Patent Application Publication
(10) Pub. No.: US 2006/0136128 A1
(43) Pub. Date: Jun. 22, 2006

(54) Method for accelerating reprocessing of a navigation route

(75) Inventor: Stephen Chen, Changhua (TW)

Correspondence Address: BRUCE H. TROXELL, SUITE 1404, 5205 LEESBURG PIKE, FALLS CHURCH, VA, 22041, US

(73) Assignee: E-Lead Electronics Co., Ltd.

(21) Appl. No.: 11/014,183

(22) Filed: Dec. 17, 2004

(51) Int. Cl. G01C 21/34

(52) U.S. Cl. 701/210; 701/209; 340/995.19

(57) ABSTRACT

A method for accelerating reprocessing of a navigation route to update the navigation route includes the procedures of (1) activating reprocessing, (2) comparing route nodes, (3) integrating the navigation routes, (4) updating the navigation route. The method does not have to repeat the entire navigation process occurred to the conventional navigation system and can rapidly update the new navigation route.

### BACKGROUND OF THE INVENTION

1. Field of the Invention

The invention relates to a method for accelerating reprocessing of a navigation route to allow a navigation system to accelerate process of updating of a navigation route and reduce process frequency and time to provide an accurate navigation route rapidly.

2. Description of the Prior Art

In the past driving a car to a destination relies on maps by following the roads shown thereon. Due to fast business and community developments, the road system becomes very complicated. Nowadays it is not uncommon that even a destination a few blocks away could be difficult to reach directly due to the restrictions of one-way streets, no-left turn roads, overpasses, rivers, and the like. Hence a desired driving route often has to be planned ahead. The navigation system now equipped in many vehicles is a helpful tool for drivers to select the optimum route.

While the conventional navigation system is adaptable for various types of road maps, process of the navigation route takes a long time. The initial process before the journey starts might be acceptable. But once the journey has started, and the actual route is different from the one being planned, the navigation system is activated to redo the navigation route process while the car is driving at a fast speed. After the re-processed route comes out, the car could be moving on a undesirable road. Then the navigation route process has to be activated again. This causes a lot of troubles.

### SUMMARY OF THE INVENTION

In view of the aforesaid problems, the present invention aims to provide a method for accelerating reprocessing of a navigation route. The method includes the steps of: (1) activating reprocessing, (2) comparing route nodes, (3) integrating navigation routes, and (4) updating the navigation route. Therefore after the vehicle is deviated from the navigation route, the navigation system still keeps the usable route sections of the route and re-does the process for only the deviated route sections to rapidly obtain the accurate navigation route.

In one aspect, the method for accelerating reprocessing of a navigation route according to the invention compares the nodes of the old and new navigation routes (the node generally is an intersection or a selected road section). A plurality of consecutive new nodes are generated on the new navigation route that are compared with the nodes of the old navigation route rather than to compare the nodes individually every time a new node is generated so that the comparing time may be saved.

In another aspect of the invention, after the new navigation route is generated to replace the old navigation route for displaying, the old navigation route still remains in the navigation system for later comparing use.

In yet another aspect of the invention, the step of activating reprocessing starts only after the navigation system has detected and confirmed that the vehicle has deviated from the original navigation route.

In another aspect of the invention, recognizing the vehicle deviation is determined according the distance of the vehicle and the navigation route, and the heading direction of the vehicle.

In still another aspect of the invention, when the vehicle deviates from the navigation route, the navigation systems activates the reprocessing for a new route. The navigation system compares with the original navigation route to locate a nearest node as an interim destination (the node usually is an intersection or a selected road section, and located on the original navigation route) to process and derive a navigation route toward the interim destination for guiding the vehicle to reach the interim destination. After arriving the interim destination, the vehicle follows the original navigation route to reduce the process time of the navigation system. The procedure includes the steps of: (1) activating reprocessing, (2) marking an interim destination, (3) processing an interim navigation route, (4) integrating navigation routes, and (5) updating the navigation route.

The method of the invention takes the approach of modifying a portion of the navigation route and nodes to enable the navigation system to accelerate the process speed. Hence there is no need to redo the process for the new navigation route every time the vehicle has deviated from the navigation route, and an accurate navigation route may be derived rapidly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the flow chart of a first embodiment of the method of the invention.

FIG. 2 is the flow chart of a second embodiment of the method of the invention.

FIG. 3 is a schematic view of a first embodiment of the invention.

FIG. 4 is a schematic view of a second embodiment of the invention.

### DESCRIPTION OF THE PREFERRED EMBODIMENTS

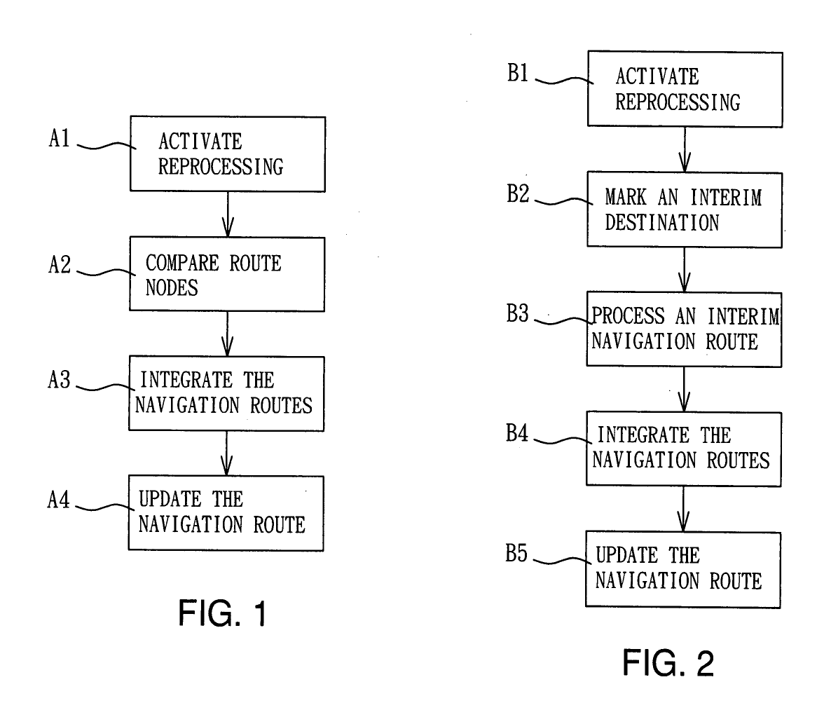

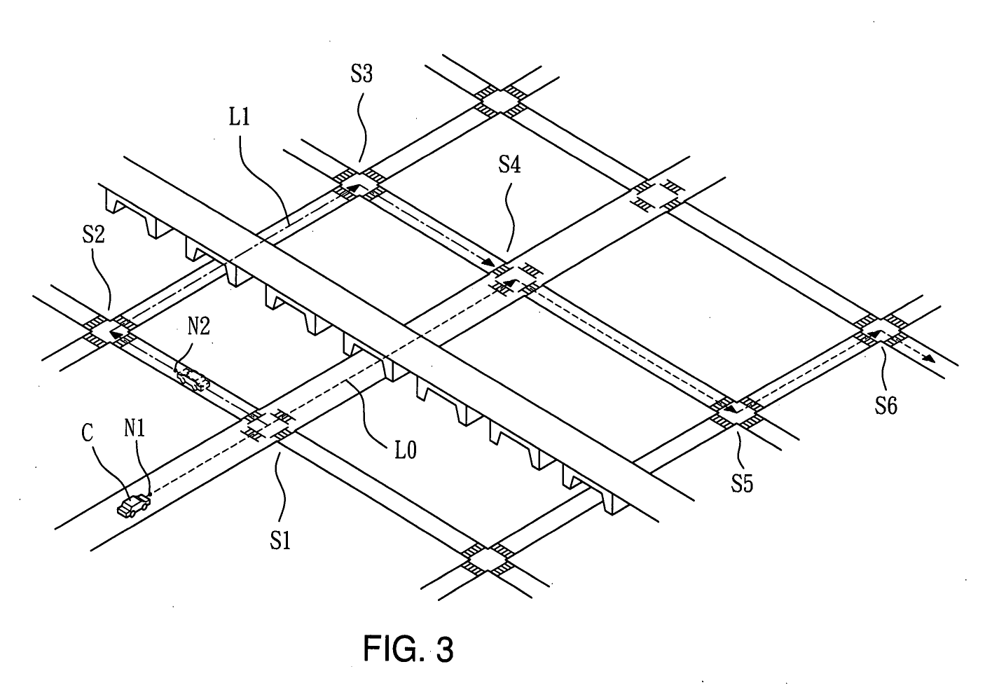

Referring to FIGS. 1 and 3, the method for accelerating reprocessing of a navigation route according to the invention includes procedures as follow:
(1) activating reprocessing (step A1): when a vehicle C drives from a first spot N1 of an original navigation route L0 and deviates to a second spot N2, the navigation system keeps the data of the original navigation route L0 and starts process a new navigation route L1;
(2) comparing route nodes (step A2): process of the new navigation route L1 uses the second spot N2 where the vehicle locates as the start point. Every new node S2 (S3, S4) being passed generates a data of the new node S2 (S3, S4) to compare with the node S4 of the original navigation route L0 (the nodes are set when the maps of the navigation system are made. They usually are intersections or selected road sections. The data of the existing nodes are used for comparison in the invention);
(3) integrating the navigation routes (step A3): at step A2, once the same node S4 is compared, the rest portion of the new navigation route L1 beyond the node S4 is not processed, and the rest portion of the original navigation route L0 beyond the node S4 is replicated to the new navigation route L1 to form a new route; and
(4) updating the navigation route (step A4): the integrated new route becomes the navigation route and the process ends.

By means of the procedures set forth above, the navigation route may be updated rapidly to avoid delay resulting from the process of the navigation system.

The step of comparing route nodes with the node S4 of the original navigation route according to the invention may be set to start only after a number of consecutive new nodes S2, S3 and S4 have been generated on the new navigation route to replace the conventional approach that individually compares with each new node being generated to save comparing time.

After the new navigation route L1 has been generated, it replaces the original navigation route L0 for displaying. But the original navigation route L0 is still maintained in the navigation system for comparing use.

The step of activating reprocessing at step A1 starts only when the navigation system has detected and confirmed that the vehicle has deviated from the original navigation route L0.

Deviation of the vehicle is determined based on the distance between the vehicle and the nearest node of the navigation route and the heading direction of the vehicle.

The node on the navigation route usually is an intersection or a selected route section.

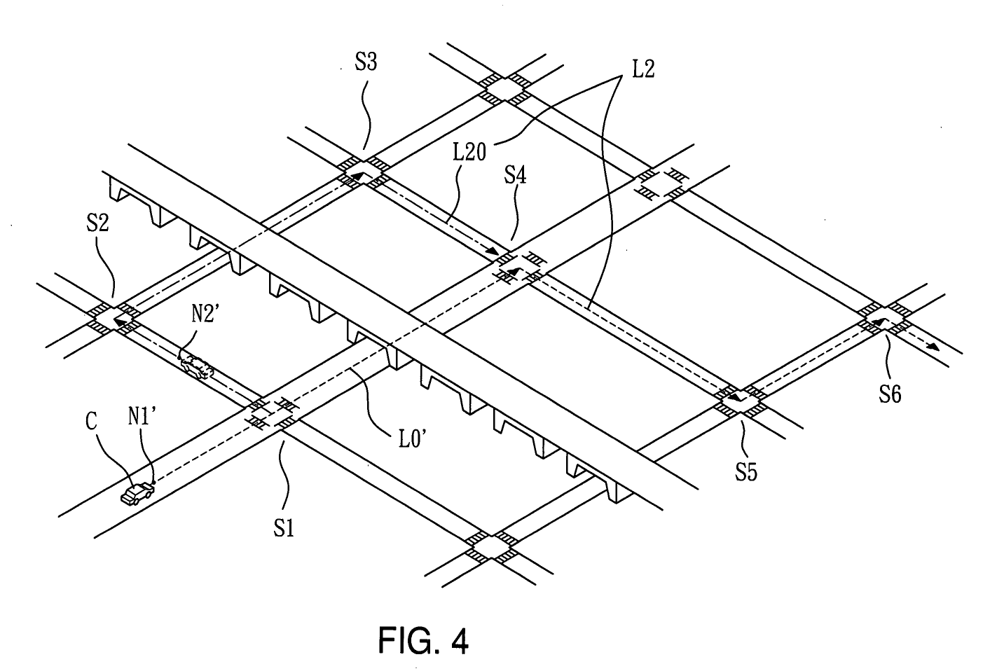

Refer to FIG. 2 for the process flow chart of a second embodiment of the invention. It includes procedures as follow:
(1) activating reprocessing (step B1): when a vehicle C drives from a first spot N1′ of an original navigation route L0′ and deviates to a second spot N2′, the navigation system keeps the data of the original navigation route L0′ (also referring to FIG. 4) and starts process for a new navigation route L2;
(2) marking an interim destination (step B2): the navigation system finds out a node S4 that is nearer to the original navigation route L0′ based on the current vehicle location, and designates the found node as an interim destination;
(3) processing an interim navigation route (step B3): the navigation system processes and derives a route between the current vehicle C location and the interim destination (i.e. node S4) as an interim navigation route L20;
(4) integrating the navigation routes (step B4): the route on the original navigation route L0′ beyond the interim destination is not processed, and is fully replicated to the new navigation route L2 to form a new route; and
(5) updating the navigation route (step B5): the integrated new route becomes the navigation route and the process ends.

By means of the method in the second embodiment set forth above, the navigation system can quickly process and derive an interim navigation route L20 when the vehicle deviates from the original navigation route without re-doing the entire routing process. Besides to speed up updating of the new navigation route, unnecessary navigation process may also be avoided.

In summary, the method provided by the invention can better meet actual requirements and alter the conventional navigation system process to get the desired route and speed up process time of the navigation system for the navigation route.

I claim:

1. A method for accelerating reprocessing of a navigation route, comprising the steps of:
(1) activating reprocessing: keeping data of an original navigation route and activating process for a new navigation route when a vehicle deviates from the original navigation route;
(2) comparing route nodes: processing the new navigation route from a start point where the vehicle is located, comparing with nodes of the original navigation route when passing each new node;
(3) integrating the navigation routes: comparing the nodes until a same node is found, stopping process of the new navigation route beyond the same node, and replicating the rest of original navigation route beyond the same node to the new navigation route to form a new route; and
(4) updating the navigation route: changing the integrated new route to become the navigation route and ending the process.

2. The method of claim 1, wherein the comparing route nodes includes generating a plurality of consecutive new nodes on the new navigation route to compare with the nodes on the original navigation route.

3. The method of claim 1, wherein the activating reprocessing starts when a navigation system detects and confirms that the vehicle has deviated from the original navigation route.

4. The method of claim 3, wherein the deviation of the vehicle is determined based on the distance between the vehicle and the navigation route and the heading direction of the vehicle.

5. A method for accelerating reprocessing of a navigation route, comprising the steps of:
(1) activating reprocessing: keeping data of an original navigation route and activating process for a new navigation route when a vehicle deviates from the original navigation route;
(2) marking an interim destination: a navigation system finding out a node that is nearer to the original navigation route based on the current vehicle location and designating the found node as an interim destination;
(3) processing an interim navigation route: the navigation system processing and deriving an interim navigation route between the current vehicle location and the interim destination;
(4) integrating the navigation routes: stopping process of the route beyond the interim destination, and replicating the rest of original navigation route beyond interim destination to the new navigation route to form a new route; and
(5) updating the navigation route: changing the integrated new route to become the new navigation route and ending the process.

6. The method of claim 5, wherein the activating reprocessing starts when the navigation system detects and confirms that the vehicle has deviated from the original navigation route.

7. The method of claim 6, wherein the deviation of the vehicle is determined based on the distance between the vehicle and the navigation route and the heading direction of the vehicle.
